(19) United States
(12) Patent Application Publication
(10) Pub. No.: US 2018/0015735 A1
(43) Pub. Date: Jan. 18, 2018

(54) WIRELESS THERMAL PRINTHEAD SYSTEM AND METHOD

(71) Applicant: Intermec Technologies Corporation, Fort Mill, SC (US)

(72) Inventors: Zhiyong Liu, Singapore (SG); Kian Kiat Chua, Singapore (SG)

(21) Appl. No.: 15/606,253

(22) Filed: May 26, 2017

Related U.S. Application Data
(63) Continuation of application No. 15/209,795, filed on Jul. 14, 2016, now Pat. No. 9,662,900.

(51) Int. Cl. B41J 2/355

(52) U.S. Cl. CPC B41J 2/3558

(57) ABSTRACT

Thermal printheads need a power and/or a data cable to deliver energy to the thermal printhead to print. With a wireless thermal printhead, however, a printer can run without using a power or a data cable. By removing the cable, benefits include shrinking the printer size, increasing durability of the printer and making it easier to change a thermal printhead.

### CROSS-REFERENCE TO RELATED APPLICATION

The present application claims the benefit of U.S. patent application Ser. No. 15/209,795 for Wireless Thermal Printhead System and Method filed Jul. 14, 2016, now U.S. Pat. No. 9,662,900. Each of the foregoing patent application and patent is hereby incorporated by reference in its entirety.

### FIELD OF THE INVENTION

The present invention relates to thermal imaging systems. In particular, the disclosed embodiments relate to systems and methods for receiving power and/or data wirelessly at a thermal printhead.

### BACKGROUND

Generally speaking thermal printheads (TPHs) need a power cable to deliver power to operate. TPHs also typically combine the power cable with a data cable which functions as a data transfer between a computer processing unit (CPU) and TPH as shown in FIG. 1. Therefore, a need exists for a wireless TPH so that the printer can run without using a power cable or data cable.

### SUMMARY

Accordingly, in one aspect, the present invention embraces wirelessly transmitting power and/or data remotely to a thermal printhead.

In an exemplary embodiment, there is an imaging system for printing on a recordable medium comprising: a thermal printhead mounted on a platform and capable of printing on the recordable medium; and a power receiver coil housing mounted on the platform and capable of receiving wireless power.

In another exemplary embodiment, there is an imaging system for printing on a recordable medium comprising: a thermal printhead mounted on a platform and capable of printing on a movable recordable medium; and a data receiver housing having an antenna capable of receiving wireless signals to control the operation of the thermal printhead.

In yet another exemplary embodiment, there is provided a method of receiving wireless power for operation of a thermal printhead comprising: receiving power wirelessly at a power receiving coil in a power receiver coil housing from an alternating magnetic field; and providing direct current power from the power receiver coil housing to a thermal printhead to enable printing on a recordable medium.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a prior art current thermal printhead with data and power cables.

FIG. 2 shows a schematic view of an example of a thermal printhead used in the embodiments disclosed herein.

FIGS. 3A and 3B schematically depict a thermal printhead powered by an inductive coil.

FIGS. 4A and 4B schematically depict a thermal printhead capable of wirelessly receiving data.

FIG. 5 schematically depicts an alternative embodiment of the thermal printhead in which the inductive coil is contained in the same housing as the wireless data receiver.

### DETAILED DESCRIPTION

All TPHs need a power and data cables to deliver energy and data to the TPH to print as shown in FIG. 1. The data cable in a thermal printer can be quite long and wide and for the case of an industrial thermal printer it can be close to 50 centimeters (cm). This causes at least two problems. First, a lot of space has to be designed to fit the cable in. Second, the signal to the TPH can be weak and interfered with by noises along the path. Similarly, a thermal printhead has a power cable, which drives the TPH to print at a specific speed and density. The power cable can also be up to 50 cm long for an industrial model thermal printer so certain space has to be kept to route the power cable as well. Due to these cables taking up space in the printer it can also be quite troublesome to change the TPH given the space constraints, especially for a printer with a small footprint. The TPH is also susceptible to external noise, which may interfere with the circuit along the cable path. With a wireless TPH, a printer can run without using a power or data cable. This has the benefit of shrinking the printer size, increasing durability as there is no more requirement to plug and unplug the power and/or data cable to the TPH, and improve TPH replacement and repair by saving TPH assembly space occupied in a thermal printer.

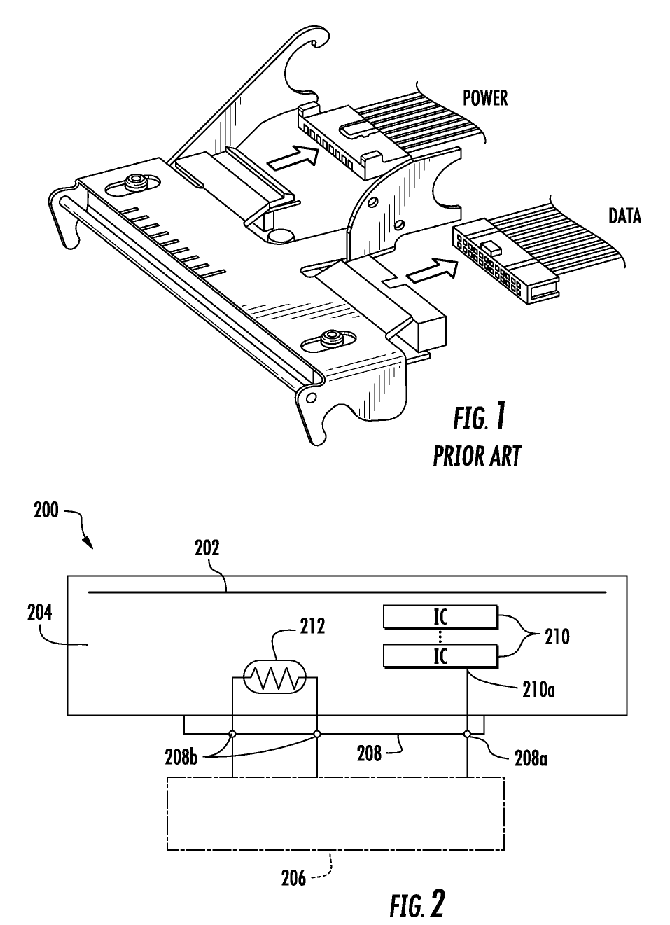

FIG. 2 shows a schematic view of a thermal printhead for use in an imaging system (e.g., printer) that may be used in the embodiments of this disclosure. The illustrated thermal printhead 200 includes a heating resistor array 202, a substrate 204, a control section 206, a connector 208, a drive integrated circuit (IC) array 210, and a thermistor 212. The substrate 204 is made of an insulating material such as ceramic and is rectangular for example. The drive IC array 210 and thermistor 212 may be arranged on. a printed circuit board or flex circuit that are mounted on substrate 204. The elongated heating resistor array 202 is also formed on substrate 204 and. is connected with the thermal printer's control section. 206 via a connector 208. The heating resistor 202 is also connected with a plurality of electrodes (not shown). These electrodes may be equally spaced along the heating resistor 202, allowing the divided portions (heating dots) of the heating resistor 202 to be energized selectively. The drive IC array 210 provides control over the printing operation through the selective power application to the heating resistor array 202 via the electrodes described above. The control section 206 sends signals necessary for performing the printing operation to drive IC array 210. These signals include, for example, a printing data signal, a clock signal, a latch signal and a strobe signal. The drive IC array 210 has a strobe signal terminal 210a, to which the strobe signal is sent via a strobe signal terminal 208a of the connector 208. The strobe signal determines a duration of time for the heating resistor 202 to be energized. While the strobe signal assumes HIGH level, the drive IC array 210 makes power available selectively to the heating resistor 202. The substrate 204 provided with a thermistor 212. The thermistor 212 is connected with the thermal printer's control section 206 via a thermistor terminal 208b of the connector 208. The connector 208 establishes an electrical connection between the thermal printhead and the thermal printer. The control section 206 obtains information on the temperature of the substrate 204 based on a resistance value of the thermistor 212. If the thermistor 212 gives an extremely small resistance value (meaning that the substrate 204 is at an abnormally high temperature), the control section 206 may stop sending printing commands to the drive IC 210 in order to prevent the thermal printhead 200 from operating abnormally or being damaged.

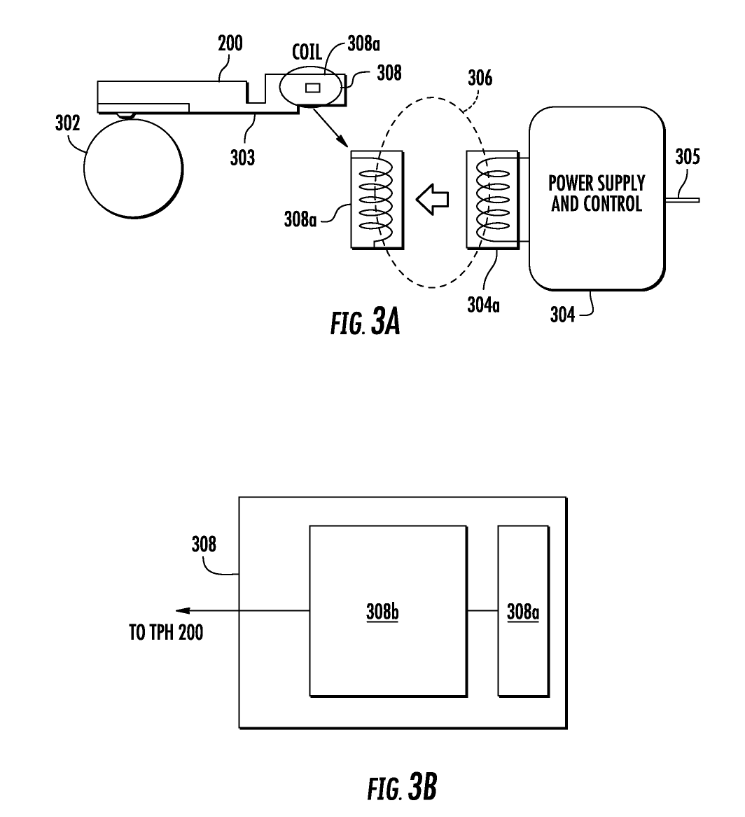

FIG. 3A shows a wireless TPH powered by an inductive coil. In FIG. 3A, TPH 200 is engaged with rotatably driven platen roller 302 which supports and guides a recording material (e.g., paper) (not shown) overlaid with a ribbon (also not shown). TPH 200 is mounted on platform 303. The speed of the drum 302 is timed to be slow enough to allow heat to penetrate the recording material and fast enough so that the recording material doesn't overheat. The recording layer of the recording web material intimately contacts the ribbon, which is in turn in contact with TPH 200. Through this process, electricity heats the small elements which melts the wax (or resin) which comes off the ribbon and sticks to the recording web material. Instead of being powered by a cable, TPH 200 receives power from a proximate power supply and control 304. A direct current (DC) power source (e.g., Mains) 305 is converted into high frequency Alternating Current (AC) by transmitter electronics inside power supply and control housing 304 (also called a transmitting coil housing). The power supply and control housing provides a control function such as frequency at the power supply side. The high frequency AC flows into transmitting inductive coil (or inductive coils) 304a which generates an oscillating magnetic field which provides power across air gap 306. Energy from the magnetic field induces AC in the receiver coil 308a located in receiver coil housing 308 also mounted on platform 303. The power typically may operate in a range of approximately 400 to 500 Watts. The distance between the transmitter coil and receiver coil housing is up to approximately 200 millimeters. In general the distance should be minimized to maintain higher efficiency. Receiver coil housing 308 is shown in greater detail in block diagram form in FIG. 3B. The wirelessly provided AC is converted back into DC by receiver electronics 308b in housing 308 and provided to the electronics of the TPH 200. Receiver electronics 308b may include a rectifier, filter, voltage regulator, capacitors and the like. By using inductive coils 304a, 308a at both the thermal printhead 200 and power supply 304, the energy can be transferred through electromagnetic field 306.

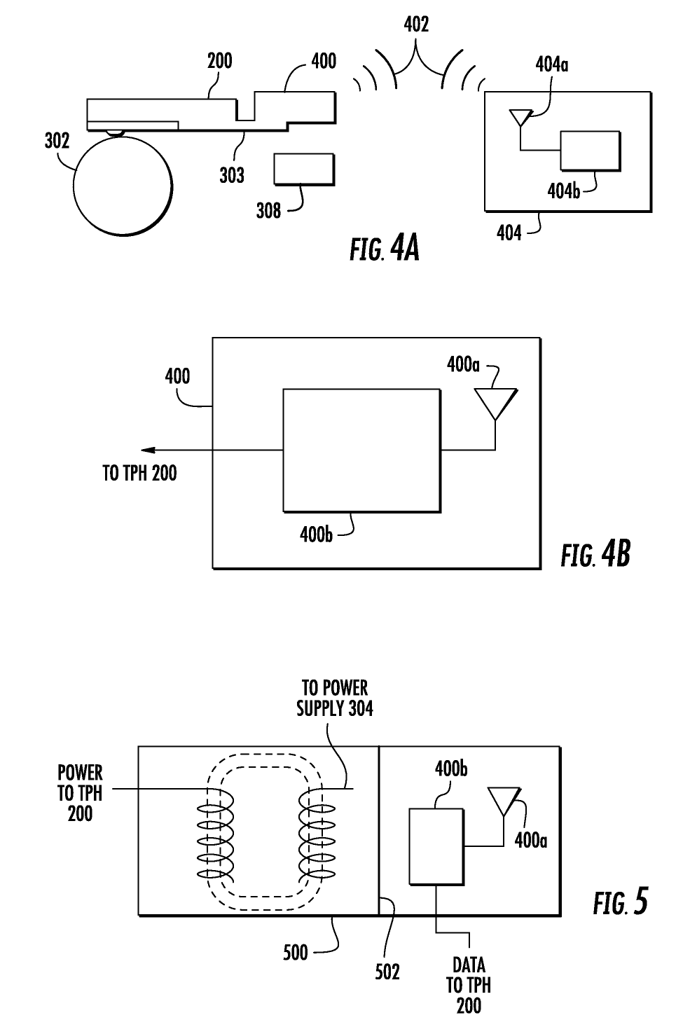

In an alternative embodiment illustrated by FIG. 4A, a data receiver housing 400 may also be mounted on the platform 303 with TPH 200 and receiver coil housing 308. The housing 400 may be integrated with housing 308 or be in a separate housing. (In an alternative embodiment, the receiver coil housing 308 may be removed and the TPH 200 can receive its power through a standard power cable while the data is received wirelessly). As shown in FIG. 4B, data receiver housing 400 contains a wireless antenna 400a capable of receiving wireless data transfer signal 402 sent from a transmitter/receiver 404 located proximate to the TPH 200. The data receiver housing 400 also contains electronic components 400b to process signal 402 and the electronic components may include an amplifier, detector, filter, oscillator and the like. Data receiver housing 400 is hardwired to thermal printhead 200 to provide data and control information. In an alternative embodiment, data receiver housing 400 also might contain a transmitter (i.e., a transceiver) to send wireless updates on the state of TPH 200 to transmitter/receiver 404. Transmitter/receiver 404 includes an antenna 404a and electronic components 404b capable of transmitting (and receiving) wireless signals. These electronic components may include an amplifier, detector, filter, oscillator and the like. Wireless signal 402 may be WiFi™, Bluetooth™, or any short-range or long-range over-the-air signal communication. Data received by the data receiver housing 400 may be commands for the TPH 200 and/or information to be printed on the recording material. The data sent by the housing 400 to transmitter/receiver 404 may include wireless authentication information to prevent a counterfeit thermal printhead from being used in the printer. In case a counterfeit printhead is being used, the transmitter/receiver 404 will stop forwarding data to housing 400 and the TPH 200.

FIG. 5 illustrates an alternative embodiment having inductance coils 308a and associated electronics 308b combined with wireless data receiver antenna 400a and its associated electronics 400b in the same housing 500 and on the same platform 303. In this embodiment there would be electromagnetic shielding 502 located between the power electronics and the data electronics to minimize interference.

Advantages of the embodiments disclosed herein include the following. First, the disclosed embodiments save thermal printhead space in thermal printers and allow for the shrinking of the printer. Second, there will be no need to plug and unplug the TPH 200 so there is no connector wear and tear and thus increase durability. Third, it will also make a thermal printhead change a hassle free job and increase user convenience.

To supplement the present disclosure, this application incorporates entirely by reference the following commonly assigned patents, patent application publications, and patent applications:

U.S. Pat. No. 6,832,725; U.S. Pat. No.

7,128,266;

U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. ,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;

### International Publication No. 2013/163789;

### International Publication No. 2013/173985;

### International Publication No. 2014/019130;

### International Publication No. 2014/110495;

### U.S. Patent Application Publication No. 2008/0185432;

### U.S. Patent Application Publication No. 2009/0134221;

### U.S. Patent Application Publication No. 2010/0177080;

### U.S. Patent Application Publication No. 2010/0177076;

### U.S. Patent Application Publication No. 2010/0177707;

### U.S. Patent Application Publication No. 2010/0177749;

### U.S. Patent Application Publication No. 2010/0265880;

### U.S. Patent Application Publication No. 2011/0202554;

### U.S. Patent Application Publication No. 2012/0111946;

### U.S. Patent Application Publication No. 2012/0168511;

### U.S. Patent Application Publication No. 2012/0168512;

### U.S. Patent Application Publication No. 2012/0193423;

### U.S. Patent Application Publication No. 2012/0203647;

### U.S. Patent Application Publication No. 2012/0223141;

### U.S. Patent Application Publication No. 2012/0228382;

### U.S. Patent Application Publication No. 2012/0248188;

### U.S. Patent Application Publication No. 2013/0043312;

### U.S. Patent Application Publication No. 2013/0082104;

### U.S. Patent Application Publication No. 2013/0175341;

### U.S. Patent Application Publication No. 2013/0175343;

### U.S. Patent Application Publication No. 2013/0257744;

### U.S. Patent Application Publication No. 2013/0257759;

### U.S. Patent Application Publication No. 2013/0270346;

### U.S. Patent Application Publication No. 2013/0287258;

### U.S. Patent Application Publication No. 2013/0292475;

### U.S. Patent Application Publication No. 2013/0292477;

### U.S. Patent Application Publication No. 2013/0293539;

### U.S. Patent Application Publication No. 2013/0293540;

### U.S. Patent Application Publication No. 2013/0306728;

### U.S. Patent Application Publication No. 2013/0306731;

### U.S. Patent Application Publication No. 2013/0307964;

### U.S. Patent Application Publication No. 2013/0308625;

### U.S. Patent Application Publication No. 2013/0313324;

### U.S. Patent Application Publication No. 2013/0313325;

### U.S. Patent Application Publication No. 2013/0342717;

### U.S. Patent Application Publication No. 2014/0001267;

### U.S. Patent Application Publication No. 2014/0008439;

### U.S. Patent Application Publication No. 2014/0025584;

### U.S. Patent Application Publication No. 2014/0034734;

### U.S. Patent Application Publication No. 2014/0036848;

### U.S. Patent Application Publication No. 2014/0039693;

### U.S. Patent Application Publication No. 2014/0042814;

### U.S. Patent Application Publication No. 2014/0049120;

### U.S. Patent Application Publication No. 2014/0049635;

### U.S. Patent Application Publication No. 2014/0061306;

### U.S. Patent Application Publication No. 2014/0063289;

### U.S. Patent Application Publication No. 2014/0066136;

### U.S. Patent Application Publication No. 2014/0067692;

### U.S. Patent Application Publication No. 2014/0070005;

### U.S. Patent Application Publication No. 2014/0071840;

### U.S. Patent Application Publication No. 2014/0074746;

### U.S. Patent Application Publication No. 2014/0076974;

### U.S. Patent Application Publication No. 2014/0078341;

### U.S. Patent Application Publication No. 2014/0078345;

### U.S. Patent Application Publication No. 2014/0097249;

### U.S. Patent Application Publication No. 2014/0098792;

### U.S. Patent Application Publication No. 2014/0100813;

### U.S. Patent Application Publication No. 2014/0103115;

### U.S. Patent Application Publication No. 2014/0104413;

### U.S. Patent Application Publication No. 2014/0104414;

### U.S. Patent Application Publication No. 2014/0104416;

### U.S. Patent Application Publication No. 2014/0104451;

### U.S. Patent Application Publication No. 2014/0106594;

### U.S. Patent Application Publication No. 2014/0106725;

### U.S. Patent Application Publication No. 2014/0108010;

### U.S. Patent Application Publication No. 2014/0108402;

### U.S. Patent Application Publication No. 2014/0110485;

### U.S. Patent Application Publication No. 2014/0114530;

### U.S. Patent Application Publication No. 2014/0124577;

### U.S. Patent Application Publication No. 2014/0124579;

### U.S. Patent Application Publication No. 2014/0125842;

### U.S. Patent Application Publication No. 2014/0125853;

### U.S. Patent Application Publication No. 2014/0125999;

### U.S. Patent Application Publication No. 2014/0129378;

### U.S. Patent Application Publication No. 2014/0131438;

### U.S. Patent Application Publication No. 2014/0131441;

### U.S. Patent Application Publication No. 2014/0131443;

### U.S. Patent Application Publication No. 2014/0131444;

### U.S. Patent Application Publication No. 2014/0131445;

### U.S. Patent Application Publication No. 2014/0131448;

### U.S. Patent Application Publication No. 2014/0133379;

### U.S. Patent Application Publication No. 2014/0136208;

### U.S. Patent Application Publication No. 2014/0140585;

### U.S. Patent Application Publication No. 2014/0151453;

### U.S. Patent Application Publication No. 2014/0152882;

### U.S. Patent Application Publication No. 2014/0158770;

### U.S. Patent Application Publication No. 2014/0159869;

### U.S. Patent Application Publication No. 2014/0166755;

### U.S. Patent Application Publication No. 2014/0166759;

### U.S. Patent Application Publication No. 2014/0168787;

### U.S. Patent Application Publication No. 2014/0175165;

### U.S. Patent Application Publication No. 2014/0175172;

### U.S. Patent Application Publication No. 2014/0191644;

### U.S. Patent Application Publication No. 2014/0191913;

### U.S. Patent Application Publication No. 2014/0197238;

### U.S. Patent Application Publication No. 2014/0197239;

### U.S. Patent Application Publication No. 2014/0197304;

### U.S. Patent Application Publication No. 2014/0214631;

### U.S. Patent Application Publication No. 2014/0217166;

### U.S. Patent Application Publication No. 2014/0217180;

### U.S. Patent Application Publication No. 2014/0231500;

### U.S. Patent Application Publication No. 2014/0232930;

### U.S. Patent Application Publication No. 2014/0247315;

### U.S. Patent Application Publication No. 2014/0263493;

### U.S. Patent Application Publication No. 2014/0263645;

### U.S. Patent Application Publication No. 2014/0267609;

### U.S. Patent Application Publication No. 2014/0270196;

### U.S. Patent Application Publication No. 2014/0270229;

### U.S. Patent Application Publication No. 2014/0278387;

### U.S. Patent Application Publication No. 2014/0278391;

### U.S. Patent Application Publication No. 2014/0282210;

### U.S. Patent Application Publication No. 2014/0284384;

### U.S. Patent Application Publication No. 2014/0288933;

### U.S. Patent Application Publication No. 2014/0297058;

### U.S. Patent Application Publication No. 2014/0299665;

### U.S. Patent Application Publication No. 2014/0312121;

### U.S. Patent Application Publication No. 2014/0319220;

### U.S. Patent Application Publication No. 2014/0319221;

### U.S. Patent Application Publication No. 2014/0326787;

### U.S. Patent Application Publication No. 2014/0332590;

### U.S. Patent Application Publication No. 2014/0344943;

### U.S. Patent Application Publication No. 2014/0346233;

### U.S. Patent Application Publication No. 2014/0351317;

### U.S. Patent Application Publication No. 2014/0353373;

### U.S. Patent Application Publication No. 2014/0361073;

### U.S. Patent Application Publication No. 2014/0361082;

### U.S. Patent Application Publication No. 2014/0362184;

### U.S. Patent Application Publication No. 2014/0363015;

### U.S. Patent Application Publication No. 2014/0369511;

### U.S. Patent Application Publication No. 2014/0374483;

### U.S. Patent Application Publication No. 2014/0374485;

### U.S. Patent Application Publication No. 2015/0001301;

### U.S. Patent Application Publication No. 2015/0001304;

### U.S. Patent Application Publication No. 2015/0003673;

### U.S. Patent Application Publication No. 2015/0009338;

### U.S. Patent Application Publication No. 2015/0009610;

### U.S. Patent Application Publication No. 2015/0014416;

### U.S. Patent Application Publication No. 2015/0021397;

### U.S. Patent Application Publication No. 2015/0028102;

### U.S. Patent Application Publication No. 2015/0028103;

### U.S. Patent Application Publication No. 2015/0028104;

### U.S. Patent Application Publication No. 2015/0029002;

### U.S. Patent Application Publication No. 2015/0032709;

### U.S. Patent Application Publication No. 2015/0039309;

### U.S. Patent Application Publication No. 2015/0039878;

### U.S. Patent Application Publication No. 2015/0040378;

### U.S. Patent Application Publication No. 2015/0048168;

### U.S. Patent Application Publication No. 2015/0049347;

### U.S. Patent Application Publication No. 2015/0051992;

### U.S. Patent Application Publication No. 2015/0053766;

### U.S. Patent Application Publication No. 2015/0053768;

### U.S. Patent Application Publication No. 2015/0053769;

### U.S. Patent Application Publication No. 2015/0060544;

### U.S. Patent Application Publication No. 2015/0062366;

### U.S. Patent Application Publication No. 2015/0063215;

### U.S. Patent Application Publication No. 2015/0063676;

### U.S. Patent Application Publication No. 2015/0069130;

### U.S. Patent Application Publication No. 2015/0071819;

### U.S. Patent Application Publication No. 2015/0083800;

### U.S. Patent Application Publication No. 2015/0086114;

### U.S. Patent Application Publication No. 2015/0088522;

### U.S. Patent Application Publication No. 2015/0096872;

### U.S. Patent Application Publication No. 2015/0099557;

### U.S. Patent Application Publication No. 2015/0100196;

### U.S. Patent Application Publication No. 2015/0102109;

### U.S. Patent Application Publication No. 2015/0115035;

### U.S. Patent Application Publication No. 2015/0127791;

### U.S. Patent Application Publication No. 2015/0128116;

### U.S. Patent Application Publication No. 2015/0129659;

### U.S. Patent Application Publication No. 2015/0133047;

### U.S. Patent Application Publication No. 2015/0134470;

### U.S. Patent Application Publication No. 2015/0136851;

### U.S. Patent Application Publication No. 2015/0136854;

### U.S. Patent Application Publication No. 2015/0142492;

### U.S. Patent Application Publication No. 2015/0144692;

### U.S. Patent Application Publication No. 2015/0144698;

### U.S. Patent Application Publication No. 2015/0144701;

### U.S. Patent Application Publication No. 2015/0149946;

### U.S. Patent Application Publication No. 2015/0161429;

### U.S. Patent Application Publication No. 2015/0169925;

### U.S. Patent Application Publication No. 2015/0169929;

### U.S. Patent Application Publication No. 2015/0178523;

### U.S. Patent Application Publication No. 2015/0178534;

### U.S. Patent Application Publication No. 2015/0178535;

### U.S. Patent Application Publication No. 2015/0178536;

### U.S. Patent Application Publication No. 2015/0178537;

### U.S. Patent Application Publication No. 2015/0181093;

### U.S. Patent Application Publication No. 2015/0181109;

U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 or MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757; for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Where a process is described in an embodiment the process may operate without any user intervention.

1. A system for printing on a recordable medium comprising:
a printhead mounted on a platform and capable of printing on the recordable medium; and
a power receiver coil located in a removable power receiving coil housing capable of receiving wireless power for providing power to the printhead.

2. The system of claim 1, wherein the power receiver coil housing includes a power receiver coil for inductively transferring power from an alternating magnetic field.

3. The system of claim 2, comprising a power transmitter coil housing capable of placing high frequency alternating current into a power transmitter coil to create the alternating magnetic field.

4. The system of claim 1, comprising a data receiver housing having a data receiver antenna capable of receiving wireless signals to control the operation of the printhead.

5. The system of claim 4, comprising a data transmitter housing having an antenna capable of transmitting wireless signals to the data receiver housing.

6. The system of claim 1, comprising a data transceiver coupled to the printhead and capable of transmitting and receiving wireless signals to report status conditions of the printhead and control the operation of the printhead.

7. The system of claim 1, comprising:
a data receiver antenna and data receiver electronics located in the power receiver coil housing and capable of receiving wireless signals to control the operation of the printhead; and
an electromagnetic shield located between the power receiving coil and the data receiver antenna and the data receiver electronics in the power receiving coil housing.

8. The system of claim 1, comprising a data transceiver capable of transmitting and receiving wireless signals containing authentication information of the printhead and control the operation of the printhead

9. An apparatus for printing on a recordable medium comprising:
a printhead mounted on a platform and capable of printing on recordable medium;
a power receiver coil capable of receiving power wirelessly for providing power to the printhead; and
a data receiver having an antenna capable of receiving wireless signals to control the operation of the printhead.

10. The apparatus of claim 9, wherein the power receiver coil includes a power receiver coil for inductively transferring power from an alternating magnetic field.

11. The apparatus of claim 9, comprising a power transmitter coil capable of placing high frequency alternating current into a power transmitter coil to create the alternating magnetic field.

12. The apparatus of claim 9, comprising a data transmitter having an antenna capable of transmitting wireless signals to the data receiver.

13. The apparatus of claim 9, comprising a data transceiver coupled to the printhead and capable of transmitting and receiving wireless signals to report status conditions of the printhead and control the operation of the printhead.

14. The apparatus of claim 9, comprising:
a data receiver antenna and data receiver electronics located capable of receiving wireless signals to control the operation of the printhead; and
an electromagnetic shield located between the power receiving coil and the data receiver antenna and the data receiver electronics.

15. The apparatus of claim 9, comprising a data transceiver capable of transmitting and receiving wireless signals; wherein the wireless signals comprise at least one of printhead authentication information and printhead control commands.

16. The apparatus of claim 9, comprising a power cable for powering the printhead.

17. A system for printing on a recordable medium comprising:
a printhead mounted on a platform and capable of printing on recordable medium;
a power receiver coil located in a power receiving coil housing capable of receiving wireless power for providing power to the printhead;
a data receiver antenna and data receiver electronics located in the power receiver coil housing and capable of receiving wireless signals to control the operation of the printhead; and
an electromagnetic shield located between the power receiving coil and the data receiver antenna and the data receiver electronics in the power receiving coil housing.

18. The system of claim 17, comprising a power transmitter coil housing capable of placing high frequency alternating current into a power transmitter coil to create the alternating magnetic field.

19. The system of claim 17, wherein the power receiver coil housing includes a power receiver coil for inductively transferring power from an alternating magnetic field.

20. The system of claim 17, comprising a data transmitter housing having an antenna capable of transmitting wireless signals to the data receiver housing.
